(19) United States
(12) Patent Application Publication
(10) Pub. No.: US 2008/0007869 A1
(43) Pub. Date: Jan. 10, 2008

(54) Disk drive and magnetic storage medium

(76) Inventors: Naoki Sato, Tokyo (JP); Yasuyuki Ito, Tokyo (JP)

Correspondence Address: HARNESS, DICKEY & PIERCE P.L.C., 5445 CORPORATE DRIVE, SUITE 200, TROY, MI, 48098, US

(21) Appl. No.: 11/825,587

(22) Filed: Jul. 6, 2007

Related U.S. Application Data
(60) Provisional application No. 60/819,075, filed on Jul. 7, 2006.

(30) Foreign Application Priority Data
Jun. 5, 2007 (JP) JP 2007-149134
Jun. 5, 2007 (JP) JP 2007-149135

(51) Int. Cl. G11B 5/74

(52) U.S. Cl. 360/131

(57) ABSTRACT

A magnetic storage medium includes a substrate. A soft magnetic material layer is arranged adjacent to the substrate. A magnetic material layer defines concentric tracks that are arranged adjacent to the soft magnetic material layer. Shield portions are arranged radially offset from and between adjacent ones of the tracks.

### CROSS-REFERENCE TO RELATED APPLICATIONS

This application claims the benefit of U.S. Provisional Application No. 60/819,075, filed on Jul. 7, 2006. This application claims the benefit of JP 2007-149134, filed Jun. 5, 2007 and 2007-149135, filed Jun. 5, 2007. This application is related to U.S. patent application Ser. No. xx/xxx,xxx, filed on (Attorney Docket No. MP1180).

The disclosures of the above applications are incorporated herein by reference in their entirety.

### FIELD

The present disclosure relates to rotating magnetic storage systems and more particularly to magnetic storage media and rotating magnetic storage systems.

### BACKGROUND

The background description provided herein is for the purpose of generally presenting the context of the disclosure. Work of the presently named inventors, to the extent it is described in this background module, as well as aspects of the description that may not otherwise qualify as prior art at the time of filing, are neither expressly nor impliedly admitted as prior art against the present disclosure.

Rotating magnetic storage systems read and write data on concentric tracks of magnetic storage media. Some magnetic storage systems use parallel recording, which magnetizes the magnetic storage medium in a direction that is parallel with a plane defined by the magnetic storage medium. Other magnetic storage systems employ perpendicular recording, which magnetizes the magnetic storage medium in a direction that is perpendicular to the plane. When reading a track, a read signal generated by a read head may be adversely impacted by crosstalk from adjacent tracks. This problem may increase as the run length increases where run length refers to the number of consecutive same symbols in the data.

### SUMMARY

A magnetic storage medium includes a substrate. A soft magnetic material layer is arranged adjacent to the substrate. A magnetic material layer defines concentric tracks that are arranged adjacent to the soft magnetic material layer. Shield portions are arranged radially offset from and between adjacent ones of the tracks.

In other features, the shield portions comprise nonmagnetic material. The shield portions have a depth that is greater than or equal to one-half of a width of the tracks. The shield portions include nonmagnetic material formed in grooves in the magnetic material layer, and the grooves have a depth greater than or equal to one-half of a width of the tracks. The magnetic storage medium further includes a protective layer arranged adjacent to the magnetic material layer and the shield portions. The magnetic storage medium further includes a lubricating layer arranged adjacent to the protective layer.

A magnetic storage medium includes a substrate. A plurality of concentric rings each include a soft magnetic material layer arranged adjacent to the substrate and a magnetic material layer having perpendicular anisotropy, defining tracks and arranged adjacent to the soft magnetic material layer. Shield portions are arranged radially offset from and between adjacent ones of the rings.

In other features, the shield portions comprise nonmagnetic material. The shield portions extend to the substrate between the rings. The magnetic storage medium further includes a protective layer arranged adjacent to the magnetic material layer and the shield portions. The magnetic storage medium further includes a lubricating layer arranged adjacent to the protective layer.

A rotating magnetic storage system includes a magnetic storage medium including tracks concentrically arranged thereon, wherein each of the tracks includes magnetic material and wherein shield portions are arranged radially offset from and between adjacent ones of the tracks. A write head records information on the tracks in a plane perpendicular to the magnetic storage medium. A read head including a magnetoresistive (MR) sensor generates a read signal based on the information. A sampling module samples the read signal. A read channel module recovers data based on the sampled read signal.

In other features, the magnetic storage medium further includes a substrate, a soft magnetic material layer arranged adjacent to the substrate, and a magnetic material layer arranged adjacent to the soft magnetic material layer. The shield portions include nonmagnetic material that extends through the magnetic material layer and the soft magnetic material layer to the substrate between adjacent ones of the tracks. The shield portions include nonmagnetic material arranged in a groove having a depth greater than or equal to one-half of a width of the tracks. The shield portions include nonmagnetic material concentrically arranged between adjacent ones of the tracks and have a predetermined depth from an outer surface of the magnetic material layer. The predetermined depth is selected to limit low-frequency noise having a frequency less than 1% of a sampling frequency of the sampling module below a predetermined value.

In other features, the magnetic storage medium further includes a protective layer arranged adjacent to the magnetic material layer and the shield portions. The magnetic storage medium further includes a lubricating layer arranged adjacent to the protective layer.

A method of forming a magnetic storage medium includes providing a substrate, forming a soft magnetic material layer adjacent to the substrate, forming a magnetic material layer defining concentric tracks adjacent to the soft magnetic material layer, and forming shield portions radially offset from and between adjacent ones of the tracks.

In other features, the shield portions comprise nonmagnetic material. The shield portions have a depth that is greater than or equal to one-half of a width of the tracks. The shield portions include nonmagnetic material formed in grooves in the magnetic material layer, and the grooves have a depth greater than or equal to one-half of a width of the tracks. The method further includes forming a protective layer adjacent to the magnetic material layer and the shield portions. The method further includes forming a lubricating layer adjacent to the protective layer. The shield portions extend to the substrate between the tracks.

In other features, the method further includes recording information on the tracks in a plane perpendicular to the magnetic storage medium, generating a read signal based on the information, sampling the read signal, and recovering data based on the sampled read signal. The depth is selected to limit low-frequency noise having a frequency less than 1% of a sampling frequency of the sampling module below a predetermined value. Forming the shield portions includes etching between the tracks.

Further areas of applicability of the present disclosure will become apparent from the detailed description provided hereinafter. It should be understood that the detailed description and specific examples, while indicating the preferred embodiment of the disclosure, are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 illustrates a rotating magnetic storage system;

FIG. 2 illustrates tracks of a magnetic storage medium;

FIG. 3 is an exemplary cross-sectional view of the magnetic storage medium;

FIG. 4 is a plan view of read and write heads;

FIG. 5 is a functional block diagram of a signal processing system for the rotating magnetic storage system;

FIG. 6 is a graph illustrating error rate of a read signal including DC components relative to run length T;

FIG. 7A is a functional block diagram of a high definition television;

FIG. 7B is a functional block diagram of a vehicle control system;

FIG. 7C is a functional block diagram of a cellular phone;

FIG. 7D is a functional block diagram of a set top box; and

FIG. 7E is a functional block diagram of a mobile device.

### DETAILED DESCRIPTION

The following description is merely exemplary in nature and is in no way intended to limit the disclosure, its application, or uses. For purposes of clarity, the same reference numbers will be used in the drawings to identify similar elements. As used herein, the phrase at least one of A, B, and C should be construed to mean a logical (A or B or C), using a non-exclusive logical or. It should be understood that steps within a method may be executed in different order without altering the principles of the present disclosure.

As used herein, the term module refers to an Application Specific Integrated Circuit (ASIC), an electronic circuit, a processor (shared, dedicated, or group) and memory that execute one or more software or firmware programs, a combinational logic circuit, and/or other suitable components that provide the described functionality.

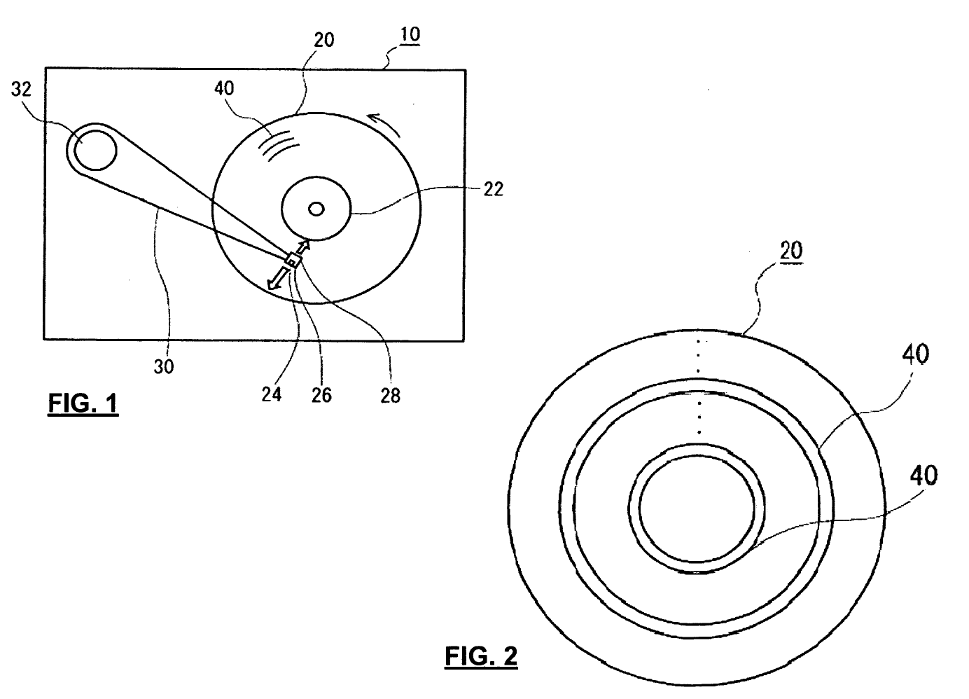

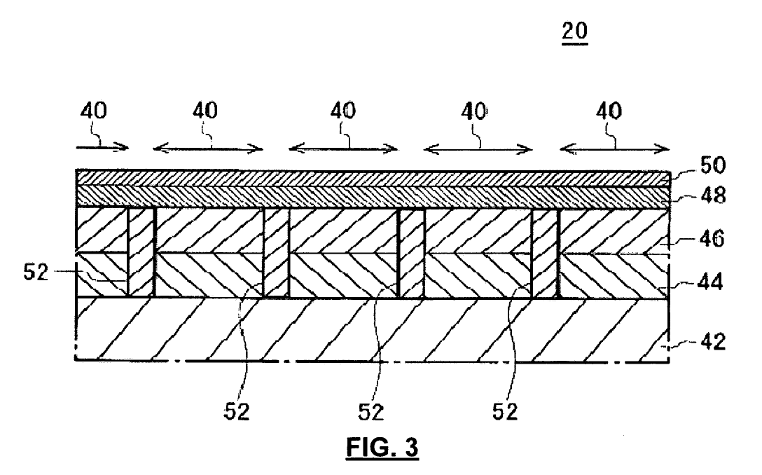

Referring now to FIGS. 1 and 2, a rotating magnetic storage system 10 and a magnetic storage medium 20 are shown. The rotating magnetic storage system 10 reads and writes data to concentric tracks of a magnetic storage medium 20 using magnetic fields. For example, the rotating magnetic storage system 10 may operate as mass data storage for a computer or other electronic device. The magnetic storage system 10 includes the magnetic storage medium 20, a spindle motor 22, a write head 24, a read head 26, a slider 28, an arm 30 and an arm actuator 32.

The magnetic storage medium 20 comprises a plurality of tracks 40 concentrically arranged thereon. Digital information is magnetically recorded on the tracks 40. The spindle motor 22 rotates the magnetic storage medium 20 during reading and writing. The write head 24 records information on the track 40 targeted for writing. For example only, parallel or perpendicular recording may be used. The read head 26 reproduces the information recorded on the track 40.

The slider 28 holds the write head 24 and the read head 26. The write head 24 and the read head 26 are disposed on the surface of the slider 28 facing a writing surface of the magnetic storage medium 20. The arm 30 movably adjusts a radial position of the slider 28 relative to the magnetic storage medium 20. The arm 30 is adapted to move the write head 24 and the read head 26 to a center of a track and/or from an innermost circumference to an outermost circumference of a track. The arm actuator 32, in turn, drives the arm 30 to move the write head 24 and the read head 26.

The magnetic storage system 10 may include a plurality of concentric magnetic storage media 20 rotationally driven at the same time by one spindle motor 22. A plurality of sliders 28, arms 30 and/or arm actuators 32 may be provided for each of the plurality of magnetic storage media 20.

The rotating magnetic storage system 10 selectively moves the write head 24 or the read head 26 in a radial direction relative to the magnetic storage medium 20 while rotating the magnetic storage medium 20. The write head 24 or the read head 26 moves to a position adjacent to the track 40 targeted for writing or reading, respectively. Then, the magnetic storage system 10 reads and/or writes data on the magnetic storage medium 20 using parallel or perpendicular recording.

Referring now to FIG. 3, an exemplary cross-section of the magnetic storage medium 20 is shown. The magnetic storage medium 20 comprises a plurality of concentric tracks 40 on which information is recorded. The magnetic storage medium 20 comprises a substrate 42, a soft magnetic material layer 44, a magnetic material layer 46, a protective layer 48, a lubricating layer 50 and shield portions 52. For example only, the substrate 42 may be made of glass or aluminum.

For example only, the soft magnetic material layer 44 may be arranged adjacent to the substrate 42 using sputtering or other suitable methods. The soft magnetic material layer 44 may be made of soft magnetic material or high permeability material. For example only, the soft magnetic material layer 44 may comprise NiFe. The soft magnetic material layer 44 may form part of a magnetic circuit through which a magnetic flux passes.

The magnetic material layer 46 may be arranged on the soft magnetic material layer 44 using sputtering or other suitable methods. Each track 40 is formed on the magnetic material layer 46. The magnetic material layer 46 may have parallel or perpendicular anisotropy so as to be magnetized parallel or perpendicular to a plane defined by the magnetic storage medium, respectively. For example only, the magnetic material layer 46 may comprise CoCrPt. The magnetic material layer 46 may be magnetized in the direction of the perpendicular anisotropy (upwardly or downwardly) by applying a perpendicular magnetic field. Additionally, the magnetic material layer 46 remains in the magnetized state after the perpendicular magnetic field is applied.

The protective layer 48 may be arranged adjacent to the magnetic material layer 46 using sputtering or other suitable methods. For example only, the protective layer 48 may comprise carbon material. The protective layer 48 reduces damage to the soft magnetic material layer 44 and the magnetic material layer 46 during an impact with the write head 24 or the read head 26. The lubricating layer 50 may be arranged on the protective layer 48 by coating or other methods. For example only, the lubricating layer 50 may comprise perfluoropolyether. The lubricating layer 50 reduces friction between the write head 24 and the read head 26 and the magnetic storage medium 20.

The shield portions 52 provide a magnetic shield between the magnetic material of each track 40. The shield portions 52 may be arranged between adjacent tracks. The shield portions 52 may comprise material such as nonmagnetic material having a magnetic permeability that is lower than that of the magnetic material 46 so that it is relatively difficult for the magnetic flux to be transmitted therethrough. For example only, the shield portion 52 may be made of SiO₂.

The shield portion 52 may be provided as follows. Areas between each of the tracks 40 may be opened by etching after the magnetic material layer 46 is provided on the soft magnetic material 44. The shield portion 52 may be arranged in the etched opening using sputtering or other suitable methods.

The shield portions 52 magnetically shield flux between the track 40 and the adjacent tracks. That is to say, the shield portions 52 reduce the magnetic flux generated from an adjacent track 40 from being read by the read head 26. This reduces noise due to crosstalk from an adjacent track. In other words, noise having a frequency that is lower than a predetermined frequency does not add to the read signal. As a result, the shield portion 52 reduces crosstalk noise included in the reproduced signal from the adjacent track 40.

The shield portion 52 may extend through the magnetic material layer 46 and/or the soft magnetic material layer 44. In other words, the magnetic material layer 46 and the soft magnetic material layer 44 for each of the tracks 40 may be completely separated by the shield portion 52. In this arrangement, the magnetic material layer 46 and the soft magnetic material layer 44 define concentric rings. Alternatively, each shield portion 52 may comprise nonmagnetic material formed in a groove having a depth greater than or equal to one-half of the width for a track from the surface of the magnetic material layer 46 of the magnetic storage medium 20.

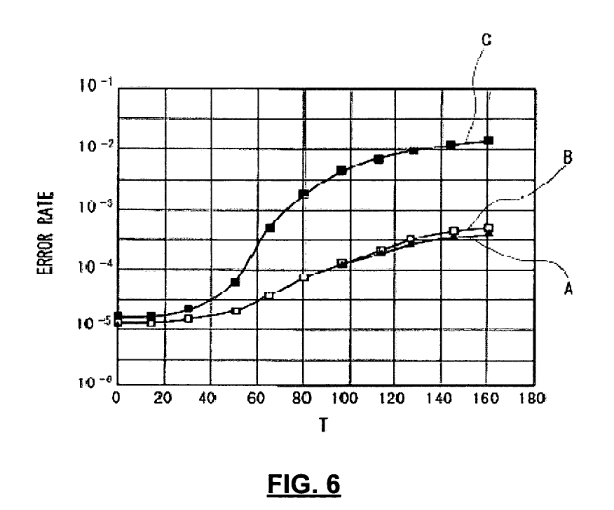

Additionally, the shield portions 52 may have a predetermined depth from the surface of the magnetic material layer 46 of the magnetic storage medium 20 sufficient to reduce the effect of low-frequency noise. The filtered noise may be associated with sequences having a run length greater than or equal to 50. The error rate of the signal reproduced by the read head 26 significantly increases when the run length of the adjacent track is more than 50 as shown in FIG. 6.

Additionally, the shield portions 52 may include nonmagnetic material having a predetermined depth to reduce low-frequency noise, which has a frequency less than 1% of a sampling frequency, below a predetermined value. Additionally, the magnetic storage medium 20 can reduce the leakage of the magnetic field applied from the adjacent track to the read head 26, and also can reduce crosstalk noise included in the reproduced signal.

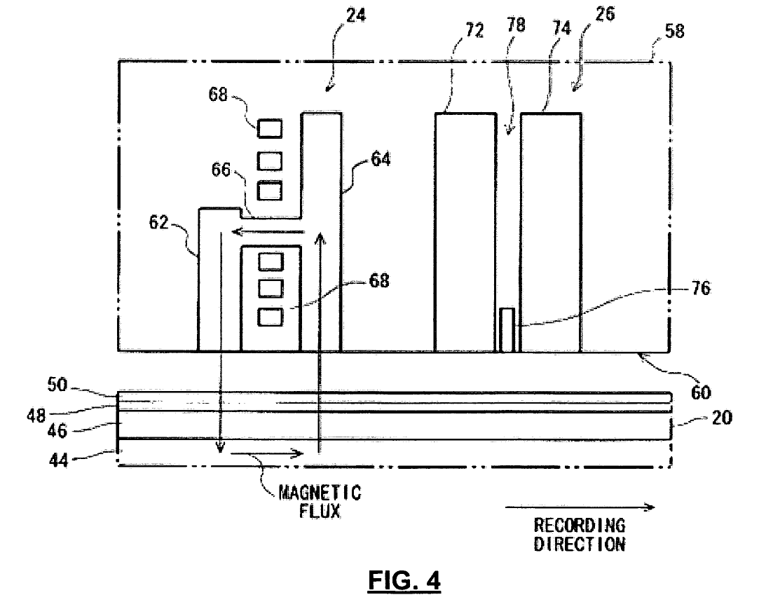

Referring now to FIG. 4, an exemplary configuration of the write head 24 and the read head 26 is shown. For example, the write head 24 may be integrally formed with a slider substrate 58 of the slider 28. The write head 24 may be arranged on a surface facing the magnetic storage medium 20 (a disc-facing surface 60) in the slider substrate 58 such that part of the write head 24 is exposed to the disc-facing surface 60.

For example only, the write head 24 may include a writing magnetic pole 62, a return magnetic pole 64, a magnetic yoke 66 and a writing coil 68. The writing magnetic pole 62 and the return magnetic pole 64 may comprise a thin film of high permeability magnetic material disposed substantially perpendicular to the plane defined by the magnetic storage medium 20. The writing magnetic pole 62 and the return magnetic pole 64 may be disposed in the writing direction of the magnetic storage medium 20 (i.e. the tangential direction of the tracks 40) and may be separated by a predetermined gap. The end surface on the disc-facing surface 60 side for each of the writing magnetic pole 62 and the return magnetic pole 64 may be exposed to the disc-facing surface 60.

The magnetic yoke 66 may comprise a thin film of high permeability magnetic material disposed substantially perpendicular to the major surface of the magnetic storage medium 20. The magnetic yoke 66 may be connected to the writing magnetic pole 62 and the return magnetic pole 64 at a predetermined position inside the slider substrate 58 relative to the disc-facing surface 60. The writing coil 68 is wound substantially around the magnetic yoke 66.

In the write head 24, a write current is applied to the writing coil 68 during writing. When the write current is applied, a magnetic flux indicated by the arrow as shown in FIG. 4 passes through the magnetic circuit including the writing magnetic pole 62, the return magnetic pole 64, the magnetic yoke 66 and the soft magnetic material layer 44. As a result, the perpendicular magnetic flux passes through the magnetic material layer 46 facing the write head 24 in the direction of the magnetic flux. For example only, the read head 26 may be integrally formed with the slider substrate 58. The read head 26 may be formed on a surface facing the magnetic storage medium 20.

The read head 26 includes a first shield 72, a second shield 74 and a magnetoresistive (MR) sensor 76. The first shield 72 and the second shield 74 may be made of high permeability magnetic material disposed substantially perpendicular to the major surface of the magnetic storage medium 20 as shown in FIG. 4. The first shield 72 and the second shield 74 define a gap 78 having a predetermined width therebetween in the writing direction of the magnetic storage medium 20. The first shield 72 and the second shield 74 comprise magnetic materials having the gap 78 substantially perpendicular to the tracks 40 therebetween. Additionally, the end surface on the disc-facing surface 60 side for each of the first shield 72 and the second shield 74 may be exposed to the disc-facing surface 60. The first shield 72 and the second shield 74 reduce the magnetic flux other than that in the perpendicular direction from being passed through the gap 78.

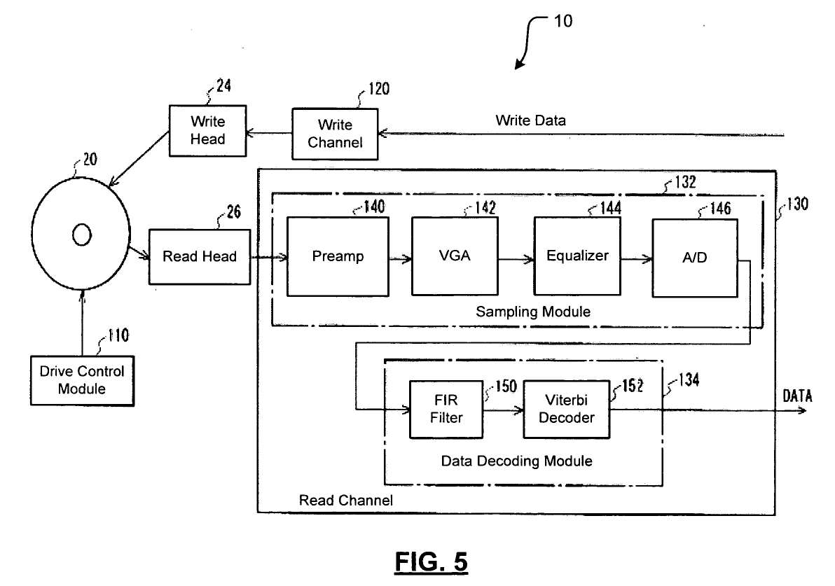

Referring now to FIG. 5, a functional block diagram of a signal processing system for the magnetic storage system is shown. The magnetic storage system 10 includes the write head 24, the read head 26, a drive control module 110, a write channel module 120, and a read channel module 130.

During reading and writing, the drive control module 110 performs rotational drive control and movement control to cause the arm 30 to move the write head 24 and the read head 26 to the position facing the track targeted for reading 40. The write channel module 120 inputs write data to be recorded on the magnetic storage medium 20 and generates a write signal of the inputted writing data. Then, the write channel module 120 outputs the write signal to the write head 24 and records the write data on the magnetic storage medium 20.

The read channel module 130 includes a sampling module 132 and a data decoding module 134. The sampling module 132 samples the voltage waveform, which changes in response to the change of the resistance of the MR sensor 76 in the read head 26 during reading. The data decoding module 134 reproduces the data based on a shape of the voltage waveform sampled by the sampling module 132. The data decoding module 134 may sample the voltage waveform including the DC response of the sampled voltage waveform and reproduce the data based on the voltage waveform.

The sampling module 132 includes a preamplifier module 140, a variable gain amplifier (VGA) module 142, a waveform equalizing module 144 and an analog to digital (A/D) converting module 146. The preamplifier module 140 detects changes in resistance of the MR sensor 76 in the read head 26 and outputs a reproduced signal indicative of the change. The VGA module 142 amplifies the reproduced signal output by the preamplifier module 140.

The waveform equalizing module 144 equalizes the waveform output by the VGA module 142. The waveform equalizing module 144 may equalize the waveform using a PR (Partial Response) that is appropriate for the read head 26. The waveform equalizing module 144 may equalize the waveform including the DC response. In other words, the waveform equalizing module 144 equalizes the voltage waveform including the DC response of the resistance of the MR sensor 76 to reproduce the magnetized signal waveform on the magnetic storage medium 20. The A/D converting module 146 samples the analog reproduced signal with a predetermined sampling frequency to digitize and output a digital reproduced signal.

Additionally, the data decoding module 134 includes a finite impulse response (FIR) filter 150 and a Viterbi decoding module 152. The FIR filter 150 equalizes the digital reproduced signal output by the sampling module 132. The Viterbi decoding module 152 Viterbi decodes the equalized digital write signal to reproduce the data recorded on the track targeted for reading 40 of the magnetic storage medium 20 and outputs the same.

Referring now to FIG. 6, an error rate of the signal including the DC component is shown relative to the number of continuous same codes (run length T). The same codes are used when the pattern is recorded on the adjacent track. Graph A of FIG. 6 shows the error rate when the run length T of the pattern recorded on the inner circumference side of adjacent track of the track targeted for reading is varied. Graph B shows the error rate when the run length T of the pattern recorded on the outer circumference side of adjacent track of the track targeted for reading is varied. Graph C shows the error rate when the run length T of the pattern recorded on both of the inner circumference side of adjacent track and the outer circumference side of adjacent track of the track targeted for reading is changed.

The error rate increases when the run length T of the pattern recorded on the adjacent track is increased as shown FIG. 6. Then, when the run length T of the signal recorded on the adjacent track is increased, the frequency of crosstalk noise mixed in the reproduced signal from the adjacent track is more reduced. Accordingly, when the signal including the DC response is reproduced from the magnetic disc of the perpendicular magnetic recording method, the error rate is increased because the low-frequency crosstalk noise is mixed in the reproduced signal from the adjacent track.

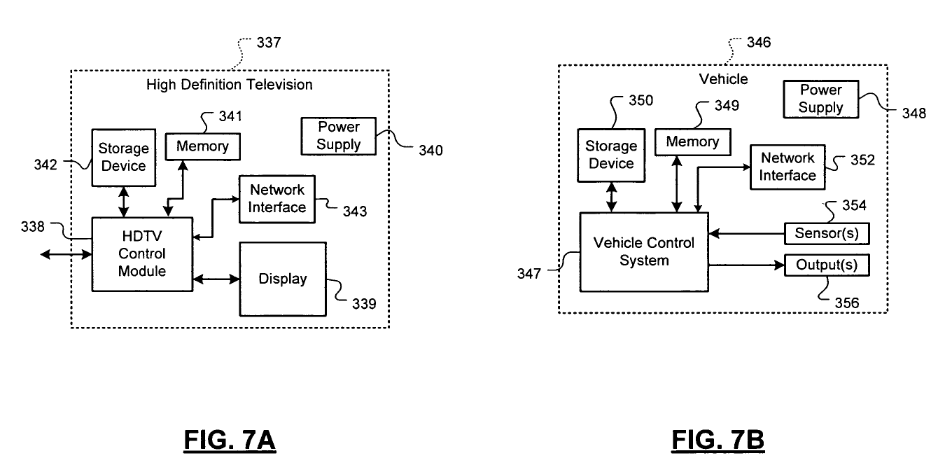

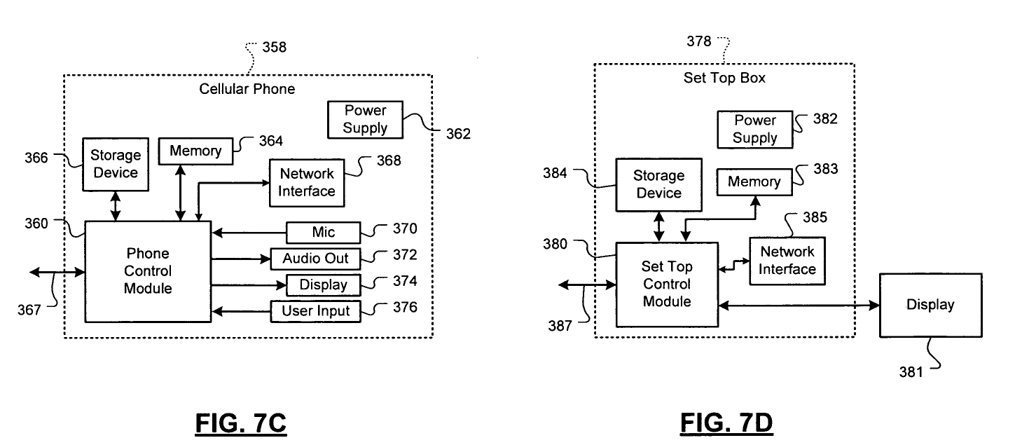

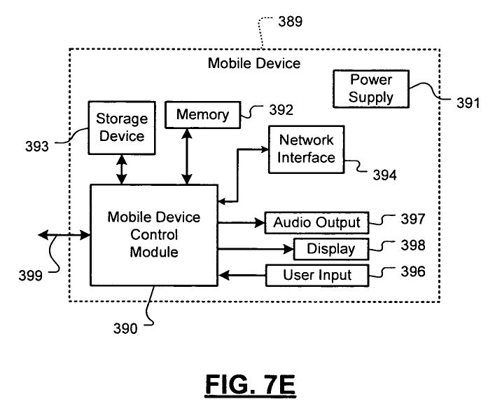

Referring now to FIGS. 7A-7E, various exemplary implementations incorporating the teachings of the present disclosure are shown.

Referring now to FIG. 7A, the teachings of the disclosure can be implemented in mass data storage of a high definition television (HDTV) 337. The HDTV 337 includes an HDTV control module 338, a display 339, a power supply 340, memory 341, a storage device 342, a network interface 343, and an external interface 345. If the network interface 343 includes a wireless local area network interface, an antenna (not shown) may be included.

The HDTV 337 can receive input signals from the network interface 343 and/or the external interface 345, which can send and receive data via cable, broadband Internet, and/or satellite. The HDTV control module 338 may process the input signals, including encoding, decoding, filtering, and/or formatting, and generate output signals. The output signals may be communicated to one or more of the display 339, memory 341, the storage device 342, the network interface 343, and the external interface 345.

Memory 341 may include random access memory (RAM) and/or nonvolatile memory. Nonvolatile memory may include any suitable type of semiconductor or solid-state memory, such as flash memory (including NAND and NOR flash memory), phase change memory, magnetic RAM, and multi-state memory, in which each memory cell has more than two states. The storage device 342 may include an optical storage drive, such as a DVD drive, and/or a hard disk drive (HDD). The HDTV control module 338 communicates externally via the network interface 343 and/or the external interface 345. The power supply 340 provides power to the components of the HDTV 337.

Referring now to FIG. 7B, the teachings of the disclosure may be implemented in mass data storage of a vehicle 346. The vehicle 346 may include a vehicle control system 347, a power supply 348, memory 349, a storage device 350, and a network interface 352. If the network interface 352 includes a wireless local area network interface, an antenna (not shown) may be included. The vehicle control system 347 may be a powertrain control system, a body control system, an entertainment control system, an anti-lock braking system (ABS), a navigation system, a telematics system, a lane departure system, an adaptive cruise control system, etc.

The vehicle control system 347 may communicate with one or more sensors 354 and generate one or more output signals 356. The sensors 354 may include temperature sensors, acceleration sensors, pressure sensors, rotational sensors, airflow sensors, etc. The output signals 356 may control engine operating parameters, transmission operating parameters, suspension parameters, etc.

The power supply 348 provides power to the components of the vehicle 346. The vehicle control system 347 may store data in memory 349 and/or the storage device 350. Memory 349 may include random access memory (RAM) and/or nonvolatile memory. Nonvolatile memory may include any suitable type of semiconductor or solid-state memory, such as flash memory (including NAND and NOR flash memory), phase change memory, magnetic RAM, and multi-state memory, in which each memory cell has more than two states. The storage device 350 may include an optical storage drive, such as a DVD drive, and/or a hard disk drive (HDD). The vehicle control system 347 may communicate externally using the network interface 352.

Referring now to FIG. 7C, the teachings of the disclosure can be implemented in mass data storage of a cellular phone 358. The cellular phone 358 includes a phone control module 360, a power supply 362, memory 364, a storage device 366, and a cellular network interface 367. The cellular phone 358 may include a network interface 368, a microphone 370, an audio output 372 such as a speaker and/or output jack, a display 374, and a user input device 376 such as a keypad and/or pointing device. If the network interface 368 includes a wireless local area network interface, an antenna (not shown) may be included.

The phone control module 360 may receive input signals from the cellular network interface 367, the network interface 368, the microphone 370, and/or the user input device 376. The phone control module 360 may process signals, including encoding, decoding, filtering, and/or formatting, and generate output signals. The output signals may be communicated to one or more of memory 364, the storage device 366, the cellular network interface 367, the network interface 368, and the audio output 372.

Memory 364 may include random access memory (RAM) and/or nonvolatile memory. Nonvolatile memory may include any suitable type of semiconductor or solid-state memory, such as flash memory (including NAND and NOR flash memory), phase change memory, magnetic RAM, and multi-state memory, in which each memory cell has more than two states. The storage device 366 may include an optical storage drive, such as a DVD drive, and/or a hard disk drive (HDD). The power supply 362 provides power to the components of the cellular phone 358.

Referring now to FIG. 7D, the teachings of the disclosure can be implemented in mass data storage of a set top box 378. The set top box 378 includes a set top control module 380, a display 381, a power supply 382, memory 383, a storage device 384, and a network interface 385. If the network interface 385 includes a wireless local area network interface, an antenna (not shown) may be included.

The set top control module 380 may receive input signals from the network interface 385 and an external interface 387, which can send and receive data via cable, broadband Internet, and/or satellite. The set top control module 380 may process signals, including encoding, decoding, filtering, and/or formatting, and generate output signals. The output signals may include audio and/or video signals in standard and/or high definition formats. The output signals may be communicated to the network interface 385 and/or to the display 381. The display 381 may include a television, a projector, and/or a monitor.

The power supply 382 provides power to the components of the set top box 378. Memory 383 may include random access memory (RAM) and/or nonvolatile memory. Nonvolatile memory may include any suitable type of semiconductor or solid-state memory, such as flash memory (including NAND and NOR flash memory), phase change memory, magnetic RAM, and multi-state memory, in which each memory cell has more than two states. The storage device 384 may include an optical storage drive, such as a DVD drive, and/or a hard disk drive (HDD).

Referring now to FIG. 7E, the teachings of the disclosure can be implemented in mass data storage of a mobile device 389. The mobile device 389 may include a mobile device control module 390, a power supply 391, memory 392, a storage device 393, a network interface 394, and an external interface 399. If the network interface 394 includes a wireless local area network interface, an antenna (not shown) may be included.

The mobile device control module 390 may receive input signals from the network interface 394 and/or the external interface 399. The external interface 399 may include USB, infrared, and/or Ethernet. The input signals may include compressed audio and/or video, and may be compliant with the MP3 format. Additionally, the mobile device control module 390 may receive input from a user input 396 such as a keypad, touchpad, or individual buttons. The mobile device control module 390 may process input signals, including encoding, decoding, filtering, and/or formatting, and generate output signals.

The mobile device control module 390 may output audio signals to an audio output 397 and video signals to a display 398. The audio output 397 may include a speaker and/or an output jack. The display 398 may present a graphical user interface, which may include menus, icons, etc. The power supply 391 provides power to the components of the mobile device 389. Memory 392 may include random access memory (RAM) and/or nonvolatile memory.

Nonvolatile memory may include any suitable type of semiconductor or solid-state memory, such as flash memory (including NAND and NOR flash memory), phase change memory, magnetic RAM, and multi-state memory, in which each memory cell has more than two states. The storage device 393 may include an optical storage drive, such as a DVD drive, and/or a hard disk drive (HDD). The mobile device may include a personal digital assistant, a media player, a laptop computer, a gaming console, or other mobile computing device.

Those skilled in the art can now appreciate from the foregoing description that the broad teachings of the disclosure can be implemented in a variety of forms. Therefore, while this disclosure includes particular examples, the true scope of the disclosure should not be so limited since other modifications will become apparent to the skilled practitioner upon a study of the drawings, the specification, and the following claims.

What is claimed is:

1. A magnetic storage medium comprising:
a substrate;
a soft magnetic material layer arranged adjacent to said substrate;
a magnetic material layer defining concentric tracks that are arranged adjacent to said soft magnetic material layer; and
shield portions arranged radially offset from and between adjacent ones of said tracks.

2. The magnetic storage medium of claim 1 wherein said shield portions comprise nonmagnetic material.

3. The magnetic storage medium of claim 2 wherein said shield portions have a depth that is greater than or equal to one-half of a width of said tracks.

4. The magnetic storage medium of claim 1 wherein said shield portions comprise nonmagnetic material formed in grooves in said magnetic material layer, and wherein said grooves have a depth greater than or equal to one-half of a width of said tracks.

5. The magnetic storage medium of claim 1 further comprising a protective layer arranged adjacent to said magnetic material layer and said shield portions.

6. The magnetic storage medium of claim 5 further comprising a lubricating layer arranged adjacent to said protective layer.

7. A magnetic storage medium comprising:
a substrate;
a plurality of concentric rings, each comprising:
a soft magnetic material layer arranged adjacent to said substrate;
a magnetic material layer having perpendicular anisotropy, defining tracks and arranged adjacent to said soft magnetic material layer; and
shield portions arranged radially offset from and between adjacent ones of said rings.

8. The magnetic storage medium of claim 7 wherein said shield portions comprise nonmagnetic material.

9. The magnetic storage medium of claim 7 wherein said shield portions extend to said substrate between said rings.

10. The magnetic storage medium of claim 7 further comprising a protective layer arranged adjacent to said magnetic material layer and said shield portions.

11. The magnetic storage medium of claim 10 further comprising a lubricating layer arranged adjacent to said protective layer.

12. A rotating magnetic storage system comprising:
a magnetic storage medium comprising tracks concentrically arranged thereon, wherein each of said tracks comprises magnetic material and wherein shield portions are arranged radially offset from and between adjacent ones of said tracks;
a write head that records information on said tracks in a plane perpendicular to said magnetic storage medium;
a read head comprising a magnetoresistive (MR) sensor that generates a read signal based on said information;
a sampling module that samples said read signal; and
a read channel module that recovers data based on said sampled read signal.

13. The rotating magnetic storage system of claim 12 wherein said magnetic storage medium further comprises:
a substrate;
a soft magnetic material layer arranged adjacent to said substrate; and
a magnetic material layer arranged adjacent to said soft magnetic material layer.

14. The rotating magnetic storage system of claim 13 wherein said shield portions comprise nonmagnetic material that extends through said magnetic material layer and said soft magnetic material layer to said substrate between adjacent ones of said tracks.

15. The rotating magnetic storage system of claim 13 wherein said shield portions comprise nonmagnetic material arranged in a groove having a depth greater than or equal to one-half of a width of said tracks.

16. The rotating magnetic storage system of claim 12 wherein said shield portions comprise nonmagnetic material concentrically arranged between adjacent ones of said tracks and have a predetermined depth from an outer surface of said magnetic material layer.

17. The rotating magnetic storage system of claim 16 wherein said predetermined depth is selected to limit low-frequency noise having a frequency less than 1% of a sampling frequency of said sampling module below a predetermined value.

18. The rotating magnetic storage medium of claim 12 further comprising a protective layer arranged adjacent to said magnetic material layer and said shield portions.

19. The rotating magnetic storage medium of claim 18 further comprising a lubricating layer arranged adjacent to said protective layer.

20. A method of forming a magnetic storage medium comprising:
providing a substrate;
forming a soft magnetic material layer adjacent to said substrate;
forming a magnetic material layer defining concentric tracks adjacent to said soft magnetic material layer; and
forming shield portions radially offset from and between adjacent ones of said tracks.

21. The method of claim 20 wherein said shield portions comprise nonmagnetic material.

22. The method of claim 21 wherein said shield portions have a depth that is greater than or equal to one-half of a width of said tracks.

23. The method of claim 20 wherein said shield portions comprise nonmagnetic material formed in grooves in said magnetic material layer, and wherein said grooves have a depth greater than or equal to one-half of a width of said tracks.

24. The method of claim 20 further comprising forming a protective layer adjacent to said magnetic material layer and said shield portions.

25. The method of claim 24 further comprising forming a lubricating layer adjacent to said protective layer.

26. The method of claim 20 wherein said shield portions extend to said substrate between said tracks.

27. The method of claim 20 further comprising:
recording information on said tracks in a plane perpendicular to said magnetic storage medium;
generating a read signal based on said information;
sampling said read signal; and
recovering data based on said sampled read signal.

28. The method of claim 22 wherein said depth is selected to limit low-frequency noise having a frequency less than 1% of a sampling frequency of said sampling module below a predetermined value.

29. The method of claim 20 wherein forming said shield portions includes etching between said tracks.
